(19) United States
(12) Patent Application Publication
(10) Pub. No.: US 2026/0299850 A1
(43) Pub. Date: Oct. 1, 2026

(54) IMAGE FORMING APPARATUS

(71) Applicant: CANON KABUSHIKI KAISHA, Tokyo (JP)

(72) Inventor: NOZOMI KUMAKURA, Chiba (JP)

(21) Appl. No.: 19/574,869

(22) Filed: Mar. 23, 2026

(30) Foreign Application Priority Data
Mar. 25, 2025 (JP) 2025-050658

(51) Int. Cl. G06F 3/12; G03G 15/00

(52) U.S. Cl. CPC G06F 3/1252; G03G 15/50; G03G 15/55; G03G 15/6544; G06F 3/1208; G03G 2215/00831

(57) ABSTRACT

An image forming apparatus includes a conveyance unit configured to convey a sheet in a conveyance direction, a printing unit configured to print an image on the sheet conveyed by the conveyance unit based on image data, and a controller configured to print an image of a first page on a downstream side of a center position of a Nth sheet in the conveyance direction, print an image of a second page on an upstream side of the center position of the Nth sheet in the conveyance direction, print an image of a third page on an upstream side of a center position of a (N−1)th sheet in the conveyance direction, print an image of a fourth page on a downstream side of the center position of the (N−1)th sheet in the conveyance direction.

### BACKGROUND

### Field of the Technology

The present disclosure relates to an image forming apparatus that is operable to perform correction with a magnification of image data.

### Description of the Related Art

In an image forming apparatus, it is desirable to control positional deviation which is a phenomenon in which an image position is displaced relative to a sheet. The positional deviation may occur due to various factors, such as a printing ratio.

The printing ratio refers to the total area of printed characters or images relative to the total area of a sheet. Higher printing ratio results in higher toner usage per sheet. Compared to forming images with a low printing ratio, forming images with a high printing ratio changes a conveyance speed of a sheet. Resultingly, the image formed on each sheet may shrink, causing the image position to deviate relative to the sheet.

Regarding positional deviation caused by the printing ratio of an image, the image forming apparatus disclosed in Japanese Patent Application Laid-open No. 2019-74586 corrects an amount of positional deviation by performing a magnification correction relative to an image size according to the printing ratio of the image to be formed.

The method described in Japanese Patent Application Laid-open No. 2019-74586 is effective in a case where the printing ration is uniform across the formed image. However, in some cases, the formed image includes both text and graphics, and the printing ratio may vary across different regions within the formed image. Thus, expected effects are not always achieved. For example, in printed product such as saddle stitched books where the sheet is folded in half and folded section is bound with staples or similar fasteners, the left and right sides of the fold become separate pages. Thus, image data having different contents may be laid out to the respective pages. When image data having different printing ratio is respectively laid out to a left side and a right side of the fold, the conveyance speed changes within the sheet surface. Therefore, even if the image magnification is corrected according to the overall printing ratio of the sheet, the positional deviation cannot be sufficiently corrected.

Furthermore, if the image that should be laid out to the left side of the fold or the image that should be laid out to the right side of the fold extends beyond the fold, it significantly degrades the quality of the printed product. Therefore, for printed products with folds, it is necessary to prioritize correcting the positional deviation of the image at the center over the positional deviation of the image at a leading or a trailing edge of the sheet in the sheet conveyance direction. However, simply correcting the magnification based on the overall image printing ratio of the sheet is insufficient for correcting the positional deviation of the image at the center. Furthermore, in saddle stitched books, with the exception of an innermost page in a case where printed products (bound booklet) are stacked and folded in half, the left and right pages of a facing-page spread that face each other when opened are each formed of different sheets. Therefore, when printing a single image that spans both left and right pages, or when printing images of the same size on each left and right page, it is necessary to match a magnification or a reduction ratio of the image in a magnification correction between pages of different sheets.

However, if the magnification is determined for each sheet, images on facing pages, such as the left and right pages forming a spread, may be corrected at different magnification, it creates a sense of incongruity. For example, in a case where the left and right pages of a spread contain the same image data and are printed on the same sheet, the printed product is equivalent to that of printing without saddle stitching. Since the images on the left and right pages are printed at a common magnification, no sense of incongruity arises. However, in a case where the left and right pages of a spread are printed on separate sheets, and the magnification used for correction differs for each sheet, the difference in magnification causes a sense of incongruity.

### SUMMARY

An image forming apparatus according to one embodiment of the present disclosure includes a conveyance unit configured to convey a sheet in a conveyance direction, a printing unit configured to print an image on the sheet conveyed by the conveyance unit based on image data, and a controller configured to print an image of a first page on a downstream side of a center position of a Nth sheet in the conveyance direction, print an image of a second page on an upstream side of the center position of the Nth sheet in the conveyance direction, print an image of a third page on an upstream side of a center position of a (N−1)th sheet in the conveyance direction, print an image of a fourth page on a downstream side of the center position of the (N−1)th sheet in the conveyance direction, perform saddle stitching in which the image of the first page and the image of the third page form a spread, and the image of the second page and the image of the fourth page form a spread, perform a magnification correction on image data for the saddle stitching such that a magnification factor of the image to be printed on the first page is equal to a magnification factor of the image to be printed on the third page, and a magnification factor of the image to be printed on the second page is equal to a magnification factor of the image to be printed on the fourth page, correct a writing position of the image to be printed on the Nth sheet by the printing unit, based on a toner amount of the image to be printed on the first page and the magnification factor of the image to be printed on the first page after the magnification correction, such that a downstream edge of the image of the second page is positioned at the center position of the Nth sheet in the conveyance direction.

An image forming apparatus includes a conveyance unit configured to convey a sheet in a conveyance direction, a printing unit configured to print an image on the sheet conveyed by the conveyance unit based on image data, and a controller configured to print an image of a first page on a downstream side of a center position of a Nth sheet in the conveyance direction, print an image of a second page on an upstream side of the center position of the Nth sheet in the conveyance direction, print an image of a third page on an upstream side of a center position of a (N−1)th sheet in the conveyance direction, print an image of a fourth page on a downstream side of the center position of the (N−1)th sheet in the conveyance direction, perform saddle stitching in which the image of the first page and the image of the third page form a spread, and the image of the second page and the image of the fourth page form a spread, perform a magnification correction on image data for the saddle stitching such that a magnification factor of the image to be printed on the first page is equal to a magnification factor of the image to be printed on the third page, and a magnification factor of the image to be printed on the second page is equal to a magnification factor of the image to be printed on the fourth page, correct a writing position of the image to be printed on the Nth sheet by the printing unit, based on a toner amount of the image to be printed on the first page and the magnification factor of the image to be printed on the first page after the magnification correction, such that an upstream edge of the image of the first page is positioned at the center position of the Nth sheet in the conveyance direction.

Features of the present disclosure will become apparent from the following description of embodiments with reference to the attached drawings. The following description of embodiments is described by way of example.

### BRIEF DESCRIPTION OF THE DRAWINGS

FIG. 1 is an explanatory diagram of a print system.

FIG. 2 is a configuration diagram of an image forming apparatus.

FIG. 3 is an explanatory diagram of a count region.

FIG. 4A is a graph for illustrating a relationship between a printing ratio and an amount of positional deviation.

FIG. 4B is a graph for illustrating a relationship between a sheet length and a positional deviation amount.

FIG. 5 is an explanatory diagram for illustrating a correction for image data.

FIG. 6 is a flowchart for illustrating a printing process.

FIGS. 7A and 7B are explanatory diagrams for explaining page numbering in saddle stitching.

FIG. 8 is a flow chart for illustrating details of image data correction.

FIG. 9 is a flow chart for illustrating image data correction processing for a first surface of a Nth sheet.

FIG. 10 is an explanatory diagram for illustrating the image data correction using specific numerical values.

FIG. 11 is a flow chart for illustrating the image data correction processing for a second surface of the Nth sheet.

FIG. 12A is a flowchart for illustrating a first flow for determining a reference image for the second surface of the Nth sheet.

FIG. 12B is a flowchart for illustrating a second flow for determining the reference image for the second surface of the Nth sheet.

### DESCRIPTION OF THE EMBODIMENTS

At least one embodiment of the present disclosure is described with reference to the accompanying drawings.

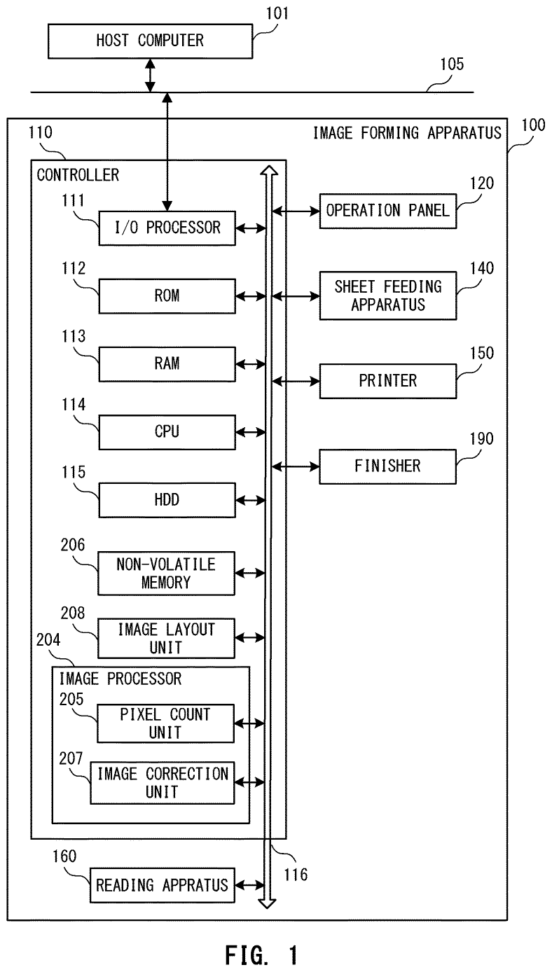

FIG. 1 is an explanatory diagram of a printing system including an image forming apparatus according to the present disclosure. The printing system includes an image forming apparatus 100 and a host computer 101. The image forming apparatus 100 and the host computer 101 are connected to each other so as to enable communication therebetween through a network 105. The network 105 is, for example, a communication line such as a local area network (LAN) or a wide area network (WAN). A plurality of image forming apparatuses 100 may be connected to the network 105, and a plurality of host computers 101 may also be connected to the network 105.

The host computer 101 is, for example, a server, and transmits a print job to the image forming apparatus 100 through the network 105. The print job includes various kinds of information required for printing, such as image data representing an image (output image) to be formed, a type of a sheet used for printing, the number of sheets to be printed, and designation of duplex or simplex printing.

The image forming apparatus 100 forms an image on a sheet based on a print job. The image forming apparatus 100 includes a controller 110, an operation panel 120, a sheet feeding apparatus 140, a printer 150, and a reading apparatus 160. The controller 110, the operation panel 120, the sheet feeding apparatus 140, the printer 150, and the reading apparatus 160 are connected to each other through a system bus 116 so as to enable communication therebetween.

The operation panel 120 is a user interface and is equipped with operation buttons, a numeric keypad, and Liquid Crystal Display (LCD). An operator can input a print job, a command, a print setting, and the like to the image forming apparatus 100 through the operation panel 120. The image forming apparatus 100 performs an image forming process based on a print job acquired from one of the host computer 101 and the operation panel 120. The operation panel 120 displays a state of the image forming apparatus 100 and a setting screen on LCD.

The sheet feeding apparatus 140 includes a plurality of sheet feeding stages that receive sheets. The sheet feeding apparatus 140 feeds one sheet at a time in order from the uppermost sheet of a bundle of a plurality of sheets (a sheet bundle) stacked on each sheet feeding stage. The sheet feeding apparatus 140 conveys, to the printer 150, the sheet fed from each sheet feeding stage. The printer 150 forms an image on the sheet fed from the sheet feeding apparatus 140 based on the image data included in the print job to generate a printed product. The reading apparatus 160 reads the printed product generated by the printer 150 to transmit a reading result thereof to the controller 110.

The controller 110 controls an operation of each part of the image forming apparatus 100. The controller 110 includes a read only memory (ROM) 112, a random access memory (RAM) 113, and a central processing unit (CPU) 114. The controller 110 includes an I/O control unit 111 and a hard disk drive (HDD) 115 as a storage. As a storage, it is also possible to use large-capacity storage devices such as a Solid State Drive (SSD) instead of the HDD. Each part within the controller 110 is connected to the system bus 116.

The I/O control unit 111 is a communication interface which communicates with an external apparatus such as the host computer 101 via the network 105. The CPU 114 comprehensively controls the operation of the image forming apparatus 100 by performing a control program stored in the ROM 112 or the HDD 115, using RAM 113 as a working area. The HDD 115 stores various data such as the control program and image data used for the image forming process (e.g., printing process).

Image data input via the network 105 is stored in a non-volatile memory 206. An image layout unit 208 combines and lay outs multiple input image data stored in non-volatile memory 206 to form a single image data according to settings configured by the operator using the operation panel 120, and stores it in the non-volatile memory 206. For example, when two pages of A4 input images are laid out on a single page of A3 print page, the two pages of A4 input image data are laid out sequentially in a sub-scanning direction (conveyance direction).

The input image data stored in the non-volatile memory 206 is input to an image processing unit 204. The image processing unit 204 includes a pixel count unit 205 and an image correction unit 207. The pixel count unit 205 accumulates density values of the respective pixels constituting the image data for each color component of Y, M, C, and K. In the present embodiment, the density value of each pixel includes 8 bits (0-255) tones. For example, as to the component of Y of the image, if the density value of the first pixel is 100 and the density value of the second pixel is 50, the accumulated value of the first and second pixels is 150. Such accumulation of pixel values is performed for all pixels within a predetermined region and for all color components.

The pixel count value calculated by the pixel count unit 205 is stored in a register (not illustrated) within the pixel count unit 205. Upon completing the count of pixels in a count region, the pixel count unit 205 sends an interrupt signal to the CPU 114. In the controller 110, the interrupt signal serves as a trigger, and based on the control program, the CPU 114 reads this register to acquire the pixel count value at that point in time.

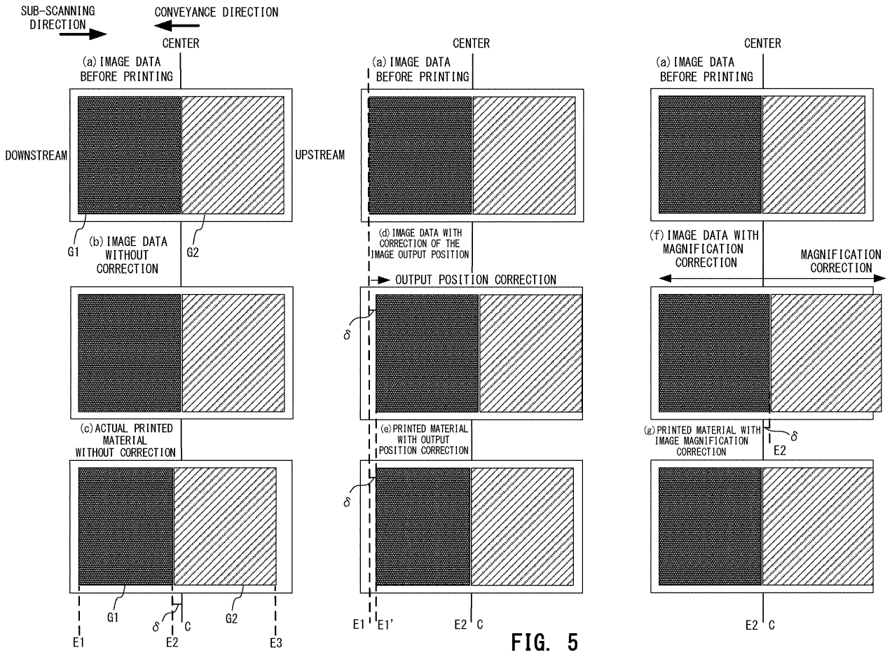

The image correction unit 207 corrects a writing position and a magnification of the image to be printed onto the sheet. The CPU 114 calculates a correction amount and sets the image writing position and the magnification of the image in the image correction unit 207. The specific method for calculating the correction amount will be described later with reference to FIG. 5.

### <Configuration of Image Forming Apparatus>

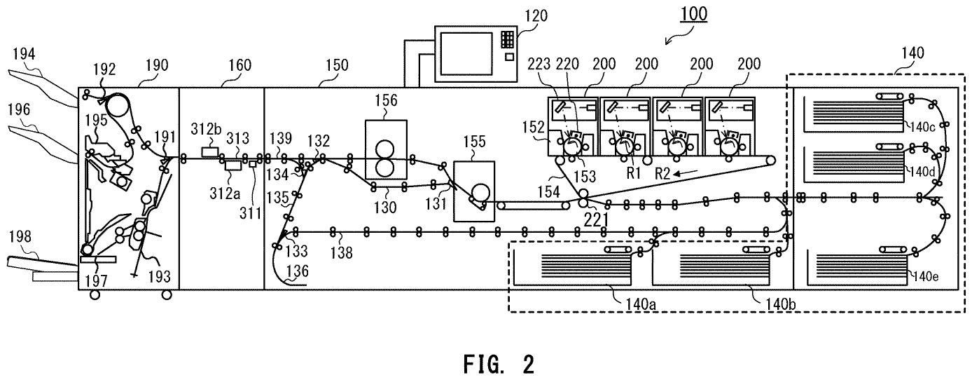

FIG. 2 is a configuration diagram of the image forming apparatus 100. The image forming apparatus 100 includes the finisher 190 in addition to the sheet feeding apparatus 140, the printer 150, and the reading apparatus 160, which have been described with reference to FIG. 1. The finisher 190 is a post-processing apparatus that performs predetermined post-processing on the printed product generated by the printer 150. The finisher 190 performs, for example, staple processing, sort processing, and the like for a plurality of the printed products.

The printer 150 includes a plurality of image forming units 200 (in the first embodiment, four image forming units) which form images of different colors. Yellow, magenta, cyan, and black images are formed by the four image forming units 200. Each of the image forming units 200 serves as a printing unit, and has substantially the same configuration.

The image forming unit 200 includes a photosensitive drum 153, which serves as an image bearing member for a toner image, a charging unit 220, an exposing device 223, and a developing device 152. The photosensitive drum 153 is driven to rotate by a drive force of a motor (not illustrated) in a direction indicated by an arrow R1. The charging unit 220 uniformly charges the photosensitive drum 153 being rotated. The exposing device 223 exposes, based on the image data, the uniformly charged photosensitive drum 153. Thus, an electrostatic latent image is formed on the photosensitive drum 153 according to the image data. The developing device 152 develops the electrostatic latent image using a developer (toner) of the corresponding color. The electrostatic latent image on the surface of the photosensitive drum 153 is visualized by the developing to form an image of the corresponding color on the photosensitive drum 153.

The printer 150 includes an intermediate transfer belt 154 onto which each image formed by a plurality of the image forming units 200 is transferred. The sheet feeding apparatus 140 includes a plurality of sheet feed stages 140a, 140b, 140c, 140d, 140e, each accommodating sheets. The sheet feeding apparatus 140 supplies sheets to the printer 150 from the sheet feed stage that contains sheets of the type (size, paper quality, etc.) specified by the print job. The sheets supplied to the printer 150 is transferred to a transfer section. The intermediate transfer belt 154 is driven to rotated in the direction of arrow R2. The yellow, magenta, cyan, and black images formed by the plurality of the image forming units 200 are transferred onto the intermediate transfer belt 154 so as to be superimposed on each other at timings corresponding to the rotational speed of the intermediate transfer belt 154. Thus, a full-color image is formed on the intermediate transfer belt 154. The image on the intermediate transfer belt 154 is conveyed due to the rotation of the intermediate transfer belt 154 to the transfer section formed between the intermediate transfer belt 154 and the transfer roller 221.

The image formed on the intermediate transfer belt 154 is transferred onto the sheet conveyed from the sheet feeding apparatus 140 at the secondary transfer nip section formed by the intermediate transfer belt 154 and the transfer roller 221. The printer 150 fixes the image onto the sheet by heating and applying pressure to the image transferred onto the sheet. The printer 150 includes a first fixing device 155 and a second fixing device 156.

The first fixing device 155 includes a fixing roller with an internal heater and a pressure belt for pressing the sheet against the fixing roller. The fixing roller and the pressure belt are driven by motors (not illustrated) to nip and convey the sheet.

The second fixing device 156 is arranged downstream of the first fixing device 155 in a conveyance direction of the sheet. The second fixing device 156 is used for increasing a gloss of the image on the sheet that has passed through the first fixing device 155 and for ensuring fixability. The second fixing device 156 includes a fixing roller with an internal heater and a pressure roller with an internal heater. Depending on a type of the sheet, the second fixing device 156 may not be used. In this case, the sheet is conveyed from the first fixing device 155 to a conveyance path 130 without being conveyed to the second fixing device 156. To that end, a flapper 131 that guides the sheet to one of the conveyance path 130 and the second fixing device 156 is provided downstream of the first fixing device 155 and the second fixing device 156.

A flapper 132 that guides the sheet to one of a conveyance path 135 and a discharge path 139 is provided downstream of the second fixing device 156 and the conveyance path 130. For example, the flapper 132 guides the sheet on which an image has been formed on a first surface in a double-sided printing mode to the conveyance path 135. For example, the flapper 132 guides the sheet on which an image has been formed on a first surface in a face-up discharging mode to the discharge path 139. For example, the flapper 132 guides the sheet on which an image has been formed on a first surface in a face-down discharging mode to the conveyance path 135. Further, after an image has been formed on a first surface of the sheet, the flapper 132 guides the sheet to the conveyance path 135 in order to print an image on a second surface of the sheet.

The sheet conveyed to the conveyance path 135 is conveyed to a reversing section 136. After a conveyance operation of the sheet conveyed to the reversing section 136 has been temporarily stopped, the sheet is reversed in the conveyance direction. A flapper 133 and a flapper 134 are provided in the conveyance path 135. The sheet reversed in the conveyance direction is guided to any one of a conveyance path 138 and the conveyance path 135 by the flapper. For example, the flapper 133 guides the sheet that has been switched back in the double-sided printing mode to the conveyance path 138. For example, the flapper 133 guides the sheet that has been switched back in the face-down discharging mode to the conveyance path 135. The sheet guided to the conveyance path 135 by the flapper 133 is guided to the discharge path 139 by the flapper 134. The flapper 133 guides the sheet that has been switched back to print an image on a second surface of the sheet to the conveyance path 138.

The sheet conveyed to the conveyance path 138 by the flapper 133 is conveyed toward the nip portion (transfer section) between the intermediate transfer belt 154 and the transfer roller 221. As a result, the front and back sides of the sheet when passing through the transfer section are reversed. That is, the surface of the sheet where the image is transferred is reversed. The finisher 190 is connected on downstream of the printer 150 in the conveyance direction of the sheet, and the printed sheet is conveyed to the finisher 190.

The reading apparatus 160 includes a document detection sensor 311 and two line sensor units 312a and 312b, arranged sequentially from the upstream side in the conveyance direction of the sheet along a conveyance path 313. Sheets conveyed from the printer 150 to the reading apparatus 160 are conveyed along the conveyance path 313. The reading apparatus 160 reads the sheet on which an image has been formed using the line sensor units 312a and 312b. After the image has been read, the sheet is conveyed along the conveyance path 313 to the finisher 190.

The document detection sensor 311 is, for example, an optical sensor having an emitting element and a receiving element. The document detection sensor 311 detects a leading edge (sheet leading edge) of the test sheet during its conveyance along the conveyance path 313 in the conveyance direction. The controller 110 initiates a reading operation of a correction chart by the reading apparatus 160 (line sensor units 312a, 312b) based on the timing of the sheet leading edge detection by the document detection sensor 311.

The line sensor units 312a and 312b read the image formed on the test sheet. The line sensor units 312a and 312b are disposed on opposite sides of the conveyance path 313 to read images from both sides of the sheet. The line sensor unit 312a reads an image formed on a front surface of the sheet. The line sensor unit 312b reads an image formed on a back surface of the sheet. In the first embodiment, the line sensor unit 312b is disposed downstream relative to the line sensor unit 312a in the conveyance direction of the sheet.

The finisher 190 performs predetermined post processing, set by the user via the print job, on the sheet conveyed along the conveyance path 313. The finisher 190 can perform post processing such as a stapling process (single point or double point binding), a punching process (two hole or three hole), and a saddle stitching process. The finisher 190 includes three discharge sections, i.e., two discharge trays 194 and 196, and a saddle stitching tray 198. The finisher 190 includes flappers 191, 192, a saddle stitching unit 193, a needle stitching unit 195, and a conveyance unit 197.

In a case where no post processing such as the stapling process is performed, the sheet is discharged to the discharge tray 194 by the flappers 191 and 192. In a case where the stapling process is performed, the sheet is conveyed to the needle stitching unit 195 by the flappers 191 and 192. The needle stitching unit 195 performs the stapling process on the conveyed sheet. The sheet to which the staple process has been performed is discharged to the discharge tray 196.

If saddle stitching process is set as the post-processing, the sheet is conveyed to the saddle stitching unit 193. The saddle stitching unit 193 performs the saddle stitching process by stapling the center of the sheet and then folding the sheet in half. Upon completion of the saddle stitching process, the bound sheet bundle (saddle stitched bundle) is discharged to the saddle stitching tray 198 via the conveyance unit 197. The saddle stitching tray 198 is configured as a belt conveyer. The saddle stitched bundle stacked onto the saddle stitching tray 198 is conveyed by a belt conveyer to the left side of FIG. 2.

### <Pixel Counting Method for Divided Region>

A method is described for setting multiple regions in the image data and performing pixel counting for each set region using the pixel count unit 205. As described later, performing pixel counting for each region enables the determination of the image shrinkage amount and an amount of positional deviation for each region. The region for which pixel counting is performed can be set arbitrarily. However, in one example, the count region is set to one page size. In a case where the page size is A4 size (height 297 mm*width 210 mm) and the resolution is set to 1200 dpi, the height (297 mm) corresponds to 14,032 pixels and the horizontal width (210 mm) corresponds to 9,921 pixels. Therefore, the pixel count unit 205 performs accumulation for 14032*9921=139,211,472 pixels per page for each color component.

As another example of the count region, the image of one page is divided along a direction (hereinafter referred to as “main scanning direction”) perpendicular to the conveyance direction, and each divided region is defined as the count region. Alternatively, the image of one page may is divided along the conveyance direction (herein after referred to as “sub-scanning direction”), and each divided region is defined as the count region. In these cases, each divided region is defined as the count region, further, multiple regions where pixel counting is performed are set in a single page.

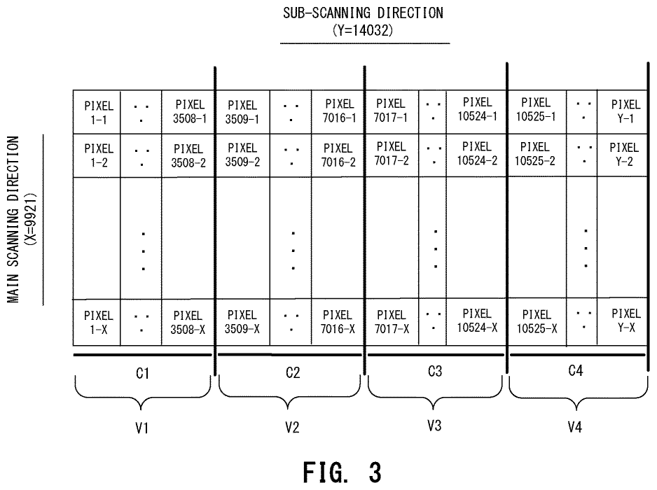

FIG. 3 is an explanatory diagram of the count region. In the illustrated example, the count regions are formed by dividing the image into n equal parts (n=4 in this example) in the sub-scanning direction. Further, the image of one page has X pixels in the main scanning direction and Y pixels in the sub-scanning direction (in this example, X=9921, Y=14032). Each count region is illustrated sequentially from the left in the sub-scanning direction as count regions C1 through C4. Each count region has 3508 pixels in the sub-scanning direction, and their lengths are each a common value L (in this example, 297/4=74.25 mm). Therefore, in the sub-scanning direction, the trailing edge of the count region C1 includes pixels 3508-1, 3508-2, . . . , and 3508-X (i.e., 9921), and the trailing edge of the count region C2 includes pixels 7016-1, 7016-2, . . . , 7016-X. Similarly, in the sub-scanning direction, the trailing edge of the count region C3 includes pixels 10524-1, 10524-2, . . . , 10524-X, and the trailing edge of the count region C4 includes pixels Y (i.e., 14032)-1, Y-2, . . . , Y-X.

In a case where input image data is input into the image processing unit 204, the pixel count unit 205 accumulates, in the main scanning direction, the density value of each pixel from a pixel 1-1 to a pixel 1-X for every color component. The calculated pixel count value is stored in an internal register of the pixel count unit 205. Next, the pixel count unit 205 accumulates, in the main scanning direction, the density value of each pixel from a pixel 2-1 to a pixel 2-X for each color component, and the accumulated value is added to the pixel count value stored in the register. Then, similar operation is continued and the accumulated value of each pixel from pixel 3508-1 to pixel 3508-X, corresponding to the position at the right edge of the count region C1 in FIG. 3, is added to the count value stored in the register. As a result, the count value stored in the register becomes the accumulated value of the density value for each color component of each pixel from pixel 1-1 to pixel 3508-X within the count region C1. In FIG. 3, the accumulated value is illustrated as a pixel count value V1. After the pixel count value V1 completes accumulation, the CPU 114 reads the register to acquire the pixel count value V1. Using the same method, the CPU 114 acquires pixel count values V2 through V4 for each of the count regions C2 through C4.

In a case where toner is interposed between the intermediate transfer belt 154 and the sheet in the secondary transfer nip section, the intermediate transfer belt 154 applies a conveying force to the sheet via the toner. A toner image carried on the photosensitive drum 153 is transferred onto the sheet while the sheet is being conveyed. As a result, the conveyance speed of the sheet changes depending on the amount of toner on the intermediate transfer belt 154, causing the image to shrink. Consequently, a positional deviation occurs between the image in the image data and the image printed on the sheet. The amount of toner present on the intermediate transfer belt 154 is hereinafter referred to as a “toner amount.” To determine the amount of the positional deviation between the image in the image data and the image printed on the sheet, in the first embodiment, a pixel count value correlated with the toner amount is used. By determining an amount correlated with the toner amount used to form the image in each count region, the toner amount in each count region is determined. The toner amount does not necessarily need to be determined directly, it is possible to determine the amount of positional deviation using an amount correlated with the toner amount. In the present embodiment, as described above, one of a count value, a density value, and a printing ratio, which are correlated with the toner amount, is used.

The pixel count unit 205 serves as a determination unit that determines the toner amount used to form the image for multiple regions set in the image data. In the following example, the printing ratio for a region is acquired from the pixel count value, and the amount of positional deviation of the image is calculated from the printing ratio. In the specification, the printing ratio is also related to density value of a pixel such that the higher the pixel density value, the higher the printing ratio. In the present embodiment, the printing ratio is acquired as (Pixel Count Value/Number of Pixels on a Sheet)*100(%). For example, for an A4 sheet (139,211,472 pixels) where the pixel count value for Y is 69,605,736 pixels, the printing ratio for toner Y is (69,605,736/139,211,472)*100=50(%). Similarly, the printing ratio for toner M, toner C, and toner K can be acquired respectively. The average of these printing ratios acquired for each toner color is the printing ratio for all toner colors. Hereinafter, the printing ratio for all toner colors acquired in this manner will be referred to simply as “toner printing ratio”. Furthermore, the printing ratio for each count region C1 through C4 is calculated as (Pixel Count Value/Number of Pixels within the Count Region)*100(%).

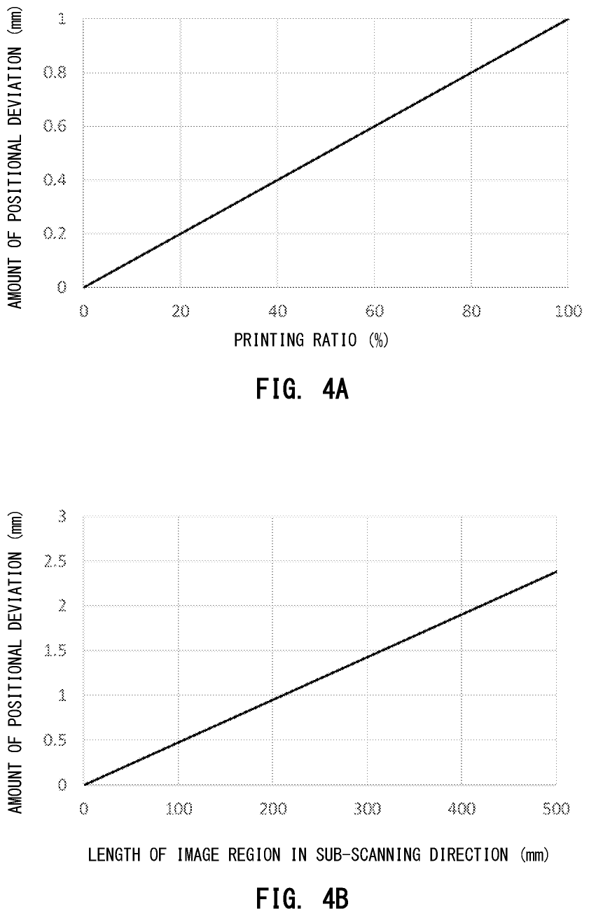

The amount of a positional deviation of an image on the sheet due to the printing ratio of the toner is explained using FIGS. 4A and 4B. FIG. 4A is a graph illustrating a relationship between the printing ratio and an amount of positional deviation of an image for image data (length of an image region in the sub-scanning direction=210 mm) to be printed on an A4 sheet. As illustrated, when printing an image with 100% printing ratio, the image deviates by 1 mm in the sub-scanning direction at the trailing edge of the printed product (i.e., the sheet with the printed image). Here, a position deviated toward the leading edge of the sheet by a predetermined margin amount from the trailing edge of the sheet is defined as an ideal position of the trailing edge of the image. A positional deviation of the image is a difference between the ideal position of the trailing edge of the image and an actual position of the trailing edge of the image. Furthermore, this graph is a straight line passing through the origin, indicating that the amount of the positional deviation and the printing ratio are in a nearly directly proportional relationship.

FIG. 4B is a graph illustrating a relationship between a length of the image region in the sub-scanning direction at 100% printing ratio and an amount of positional deviation of the trailing edge of the image formed on the sheet. As illustrated, this graph is a straight line passing through the origin, the amount of positional deviation is approximately (1/210) times the length of the image area in the sub-scanning direction, and is in a nearly directly proportional relationship.

In the first embodiment, assuming that the positional deviation of the image is proportional to both the printing ratio and the length of the image region in the sub-scanning direction, the positional deviation at the trailing edge of the image formed on the sheet (trailing edge of the image) is acquired as illustrated in the following Equation 1.

Positional deviation (mm)={Length of image data in sub-scanning direction (mm)}*{Printing ratio*(1/210)} Equation 1

As to Equation 1, the length of the sheet in the sub-scanning direction in the output image is 210 mm for A4 size, 297 mm for A4R size, and 420 mm for A3 size. As described above, in a case where the printing ratio is 100%, the positional deviation amount corresponding to the A3 image data is 2 mm, and the positional deviation amount corresponding to the A4 image data is 1 mm.

In a case where the image data is divided into multiple regions (count regions C1 through C4), the count value is determined for each region. Thus, the image shrinkage amount can be determined for each of the count regions C1 through C4. Further, for each edge of the count regions C1 through C4, it is possible to determine the amount of positional deviation between the edge position in the image data and the edge position on the sheet.

In a case where the image shrinkage amount for the count region C1 is 0.6 mm, and the shrinkage amount for the count region C2 is 0.4 mm, the positional deviation of the trailing edge of the count region C1 (and the leading edge of the count region C2) from the image leading edge is 0.6 mm. On the other hand, the positional deviation of the trailing edge of the count region C2 (and the front end of the count region C3) from the image leading edge is the sum of the shrinkage amounts for count regions C1 and C2 (0.6+0.4=1.0 mm). Similarly, by accumulating the shrinkage amounts for each count region, the positional deviation of the front and rear ends of the count regions C3 and C4 from the image leading edge can also be determined.

In this embodiment, coefficients for the calculation formula in FIGS. 4A and 4B are determined from experimentally acquired values. However, the coefficients for the calculation formula may also be determined by printing test charts for different printing ratios and detecting the image positional deviation amount using the reading apparatus 160. Furthermore, the calculation formula is not limited to the form of Equation 1. Any approximation formula, such as linear approximation, quadratic approximation, polynomial approximation, or power approximation, can be used as long as it allows the positional deviation to be calculated.

### <Method for Centering the Image>

Next, printed products intended for printing where the sheet is to be folded in half (divided into two equal parts), or into three, four, or n equal parts, such as saddle stitched books (also referred to as “book binding and printing”) or folded pamphlets are described. Such printed products have folds. For example, when folding the sheet in half, the position corresponding to the center of the image data corresponds to the position of the fold that is positioned at a sheet center position on the printed product. For convenience, in the present disclosure, in printing that is intended to be folded, the printed product may be described as having a fold even before the fold is actually formed. Particularly, in a case where the image layout unit 208 lays out n images to a single image data for printing, it is important that the boundaries between images in the image data correspond to the fold line on the printed product.

On the other hand, as to the image after performing lay out processing by the image layout unit 208, the printing ratio may differ for each laid out image. For example, in a case where two images are laid out, the printing ratio of the image laid out downstream in the conveyance direction may differ from that of the image laid out upstream. In this case, differences in the image shrinkage cause positional deviation between the center position of the image data and the center position (fold) of the sheet, i.e., the printed product, where the image is formed. The following description describes an example where the center position of the image data is aligned with the sheet center position even in such cases.

FIG. 5 illustrates an explanatory diagram of correction for image data where the printing ratio of the image on the downstream side in the sheet conveyance direction is high, and the printing ratio of the image on the upstream side is low. In FIG. 5, the conveyance direction is leftward, and the right side of the sheet is upstream, while the left side is downstream. In FIG. 5, the sheet is A3 size, and the positional deviation of a downstream edge of the image in the downstream half region of the sheet (hereinafter referred to as “image G1”) in the conveyance direction is 1 mm. Further, the sheet center position (indicated as “CENTER” in FIG. 5) corresponds to a fold position in saddle stitching. The shrinkage amount of the image in the upstream half region in the conveyance direction (hereinafter referred to as “image G2”) is shorter compared to the shrinkage amount of the image G1. In a case where the images G1 and G2 are laid out as pages to be printed, the image G1 corresponds to the first page formed downstream of the sheet center position, and the image G2 corresponds to the second page formed upstream of the sheet center position. Furthermore, to avoid complicating the drawings, the symbols G1 and G2 representing images G1 and G2, respectively, are illustrated only in (a) and (c) in FIG. 5. Additionally, the printing ratio for each of the images G1 and G2 is acquired from the sum of the density values for each color component of each pixel contained within the image, similar to the count regions C1 through C4 in FIG. 3.

Hereinafter, in the images G1 and G2, the downstream edge in the conveyance direction illustrated in FIG. 5 is referred to as “leading edge”, and the upstream edge in the conveyance direction is referred to as “trailing edge”. In FIG. 5, (a) illustrates the image data before printing, and (b) illustrates the image data when no correction based on the print density is applied by the image correction unit 207. In this case, since no correction is applied to the image data, in FIG. 5, (a) and (b) are identical. In FIG. 5, (c) illustrates the actual printed product in a case where the image data is printed without correction. As illustrated, since the image G1 has a high printing ratio, it is shrunk on the printed product, with a reduction amount of 1 mm. Consequently, the trailing edge of the image G1 (and the leading edge of the image G2) is printed 1 mm to the left of the image center position. The image G2 is also shrunk according to its printing ratio. However, in the illustrated example, as described later, the printing ratio of the image G2 is lower than that of the image G1, resultingly, the substantial positional deviation is 0 mm.

For simplicity, in FIG. 5, (c) illustrates the leading edge of the image G1 as E1, the trailing edge of the image G1 as E2, and the trailing edge of the image G2 as E3. Furthermore, the leading edge of the image G2 coincides with the trailing edge of the image G1, and both are illustrated as E2.

In FIG. 5, as to (c), the positional deviation amount of the image G1 is illustrated as the distance “δ” between the trailing edge E2 of the image G1 and the center of the sheet (indicated as “C” in FIG. 5). As described above, in (c) through (g) of FIG. 5, 8=1 mm. As a result of this positional deviation, the center of the sheet is located within image G2. Thus, in a case where the sheet is folded in half, the fold is positioned within the image G2, leading to a decrease in print quality. As examples to resolve this positional deviation in the image, two methods, i.e., a method of changing the image writing position relative to the leading edge of the image G1, and a method of changing the image magnification in the conveyance direction will be described.

In FIG. 5, (d) illustrates image data when performing a center position correction to correct the image writing position by calculating the amount of the positional deviation of the image based on the printing ratio to correct the image data writing position. The image correction unit 207 corrects the image data by adjusting the writing position so that the amount of the positional deviation 8 is suppressed or compensated. As a result, the image data output timing is delayed by an amount such that the position of the leading edge E1′ of the image G1 on the printed product is deviated by δ (equal to 1 mm) relative to the leading edge E1 of the image G1.

In FIG. 5, (e) illustrates the printed product with the writing position corrected, where the trailing edge of the image G1 is positioned at the sheet center position. In the illustrated example, since the positional deviation amount 8 of the trailing edge of the image G1 in the conveyance direction of the A3 sheet is 1 mm, the output timing is delayed so that the writing position in the conveyance direction is displaced by 1 mm.

On the other hand, in FIG. 5, (f) illustrate the image data with its magnification corrected by the image correction unit 207. The magnification factor is determined to suppress the amount of the positional deviation amount & caused by shrinking of the image G1 in accordance with the printing ratio. Then, magnification correction is performed by multiplying the image data by the determined magnification factor to enlarge the entire image data to correct the image data. Prior to printing, the image data is enlarged after multiplying by the determined magnification factor. In the example of (f) of FIG. 5, the image data after the magnification correction is larger than the size of the sheet.

In FIG. 5, (g) illustrates the printed product with the image magnification corrected, where the trailing edge of the image G1 is positioned at the sheet center position. Since the amount of the positional deviation 8 of the trailing edge of the image G1 in the conveyance direction of the A3 sheet is 1 mm, when applying a constant magnification to the entire A3 image for magnification correction, the amount of the positional deviation of the trailing edge of the image data is twice the 1 mm in the conveyance direction, i.e., 2 mm. Further, since the length of the A3 sheet in the conveyance direction is 420 mm, the magnification factor multiplied across the entire image data is set to 422 mm/420 mm=1.004. This enables positioning the trailing edge of the image G1 at the sheet center position in the printed product.

### <Printing Flow>

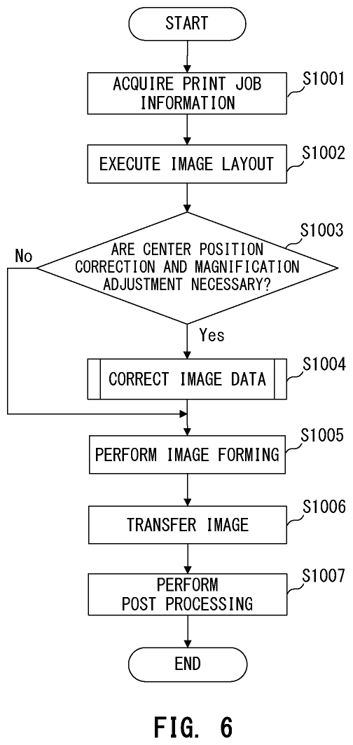

FIG. 6 is a flowchart illustrating the printing process. In a case where an operator submits a print job containing print commands, the CPU 114 acquires the print job information from the host computer 101 (Step S1001). The CPU 114 performs image layout on a single sheet for multiple images according to the job information by the image layout unit 208 (Step S1002). The CPU 114 determines whether the center position correction and a magnification adjustment, which is an adjustment to ensure an identical magnification factor for image magnification between adjacent pages in a spread, are necessary or not based on the print job information acquired in Step S1001 (Step S1003). In this embodiment, in a case where the print job is a saddle stitching job that folds the sheet at the center position and performs binding, image data correction processing is determined to be necessary and the center position correction and the magnification adjustment, which are described above, are performed. These center position correction and the magnification adjustment are applicable not only to saddle stitching but to any print job that folds the sheet to perform binding.

In a case where the center position correction and the magnification adjustment are not required (Step S1003: No), the CPU 114 performs image forming using the image forming unit 200 without correcting the image data (Step S1005). Then, the CPU 114 transfers the image (Step S1006) and controls the post processing apparatus to perform post processing (Step S1007), thereby completing the printing job. In a case where the center position correction and the magnification adjustment are required (Step S1003: Yes), the CPU 114 corrects the image data by using the image correction unit 207 (Step S1004) so that the image position on the printed product is corrected and the magnification adjustment is performed. Details of the flow is described later. The CPU 114 performs the image formation using the image data corrected in Step S1004 using the image forming unit 200 (Step S1005), transfers the formed image onto the sheet (Step S1006), and controls the post processing apparatus to perform post processing, and completes printing (Step S1007).

### <Image Data Correction Flow>

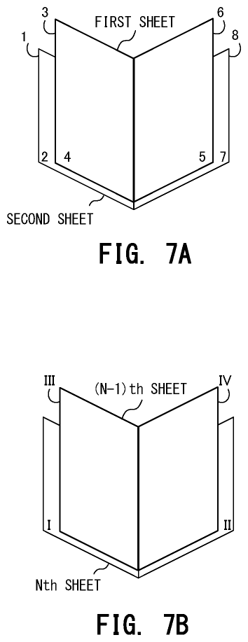

In the following, the image data correction processing for saddle stitching, where images are centered on the sheet and the magnification factor is made identical (or within a predetermined range deemed identical) across adjacent pages (spread pages) in the printed product, is described using FIG. 7A through FIG. 10. In the following example, left-opening saddle stitching is used. To simplify the description, the total number of pages is eight, with the front cover being page 1 and the back cover being page 8. The number of images included in print data is not limited. In the following example, however, image G1 and image G2 are included, and the images G1 and G2 are placed on two pages adjacent to each other with a fold interposed therebetween.

FIG. 7A is an explanatory diagram of page numbering in saddle stitching. Although this example uses left-opening binding, whether left-opening or right-opening, the same magnification factor is used for the magnification correction on adjacent pages within a spread. Therefore, the present disclosure is applicable regardless of left-opening or right-opening binding. As for the conveyance path 130 described above, two sides of the sheet are referred to as a first surface (here, a front surface) where images are printed first, and a second surface where images are printed later. Pages 4 and 5 are printed on the first surface of a first sheet, and pages 3 and 6 are printed on the second surface (here, a back surface) of the first sheet. Pages 2 and 7 are printed on the first surface of a second sheet, and pages 1 and 8 are printed on the second surface of the second sheet. Therefore, during printing, images of pages that becomes innermost pages when the printed sheets are stacked and folded in half (in this example, pages 4 and 5) is printed on the front surface of the first sheet.

As illustrated, when opened as a spread, pages 2 and 3, pages 4 and 5, and pages 6 and 7 appear as pairs on the left and right. Here, pages 4 and 5 are on the same sheet (the first sheet). Although page 2 and page 3 form the spread, page 2 is printed on the second sheet, and page 3 is printed on the first sheet, that is, they are printed on different sheets. In the present disclosure, printing where pages adjacent across a fold (the left and right pages of the fold) on the spread in the printed product are printed on different sheets is referred to as “saddle stitching” including saddle stitch binding and binding printing. FIG. 7B is an explanatory diagram of alternative embodiment of pagination in saddle stitching. In FIG. 7B, for the first surface of the Nth sheet, the page printed downstream of the center position of the Nth sheet during conveyance through the secondary transfer nip is designated as a first page, and the page printed upstream of the center position of the Nth sheet is designated as a second page. Similarly, for the second surface of the (N−1) th sheet, the page printed upstream of the center position of the (N−1)th sheet as it passes through the secondary transfer nip is designated as a third page, and the page printed downstream of the center position is designated as a fourth page. To distinguish from the page description for left-opening in FIG. 7A, first page is labeled “I” in FIG. 7B. Similarly, the second page, the third page, and the fourth page are labeled “II,” “III,” and “IV”, respectively. As illustrated, in this example, the image on the first page forms the spread with the image on the third page, and the image on the second page forms the spread with the image on the fourth page.

In the present embodiment, the center position correction is performed on the image data formed on the sheet, and, if necessary, the magnification adjustment is performed so that pages adjacent to each other in a spread across a fold have the same magnification factor. In a case where pages adjacent across the fold in the printed product are printed on different sheets (i.e., a first sheet and a second sheet different from the first sheet), by performing the magnification adjustment, the same magnification factor is applied to the image data on the first sheet and the image data on the second sheet. To perform this magnification adjustment, it is determined whether the magnification correction for the image data has already been performed for either the first sheet or the second sheet.

For example, in a case where the image data of the second surface of the first sheet (i.e., the surface containing pages 3 and 6) illustrated in FIG. 7A, the image data containing pages adjacent across the fold is the first surface of the second sheet (the surface containing pages 2 and 7). Therefore, it is determined whether the magnification correction has already been performed on the image data of the first surface of the second sheet containing these pages. In a case where the magnification correction has not been performed, there is no need to perform the magnification adjustment to make magnification factors of pages adjacent to each other in a spread across a fold identical. In this case, the CPU 114 performs correction processing, including the center position correction, on the image data to be corrected. On the other hand, in a case where the magnification correction has already been performed on the image data for the first surface of the second sheet, the CPU 114 performs correction processing on the image data to be corrected. This processing includes both the magnification adjustment to match the already performed magnification correction and the center position correction. Thus, deviations of image positions at the center position between pages adjacent to each other in a spread is reduced, and the magnification correction is performed using a common magnification factor.

The following describes an example in which printing is performed using saddle stitching, in which an image is printed on the first surface of the sheet and then an image is printed on the second surface of the sheet. The explanation is divided into correction processing for the image data on the first surface of the sheet and correction processing for the image data on the second surface of the sheet. The page of the second surface of the sheet printed first (i.e., the (N−1)th sheet) and the page of the first surface of the sheet printed next (the Nth sheet) become adjacent pages across the fold.

Therefore, in this embodiment, the magnification factor for magnification correction is sequentially determined for the first surface of the first sheet, the second surface of the first sheet, the first surface of the second sheet, the second surface of the second sheet, and so on. Further, the magnification factor for the magnification correction for the second surface of the (N−1)th sheet is stored in the non-volatile memory 206. For the first surface of the Nth sheet, the magnification adjustment on the first surface is performed using this stored magnification factor. While there is no previously printed sheet for the first surface of the first sheet, in printing, the first sheet constitutes the innermost two pages of the printed product in the saddle stitching, and these pages are printed on the same sheet. Therefore, no magnification adjustment is performed for the first surface of the first sheet. Further, for the second surface of the (N−1)th sheet, the center position correction is performed, but no magnification adjustment is made to match the magnification factor of the adjacent left and right pages in a spread. Since the magnification adjustment occurs in a case where the image data for the first surface of the subsequent next sheet (the Nth sheet) is corrected, at the center position, the deviation of the image position between adjacent left and right pages in the spread is suppressed. This enables applying the same magnification correction to adjacent left and right pages in a spread.

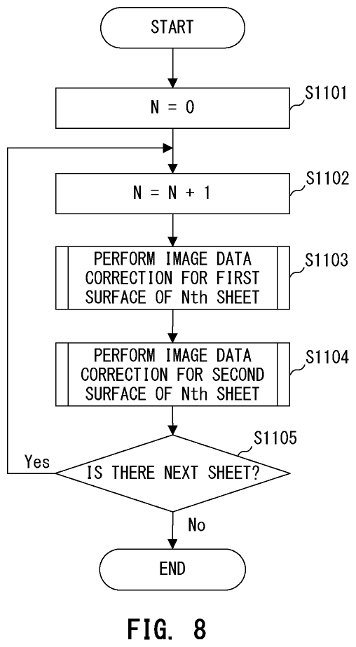

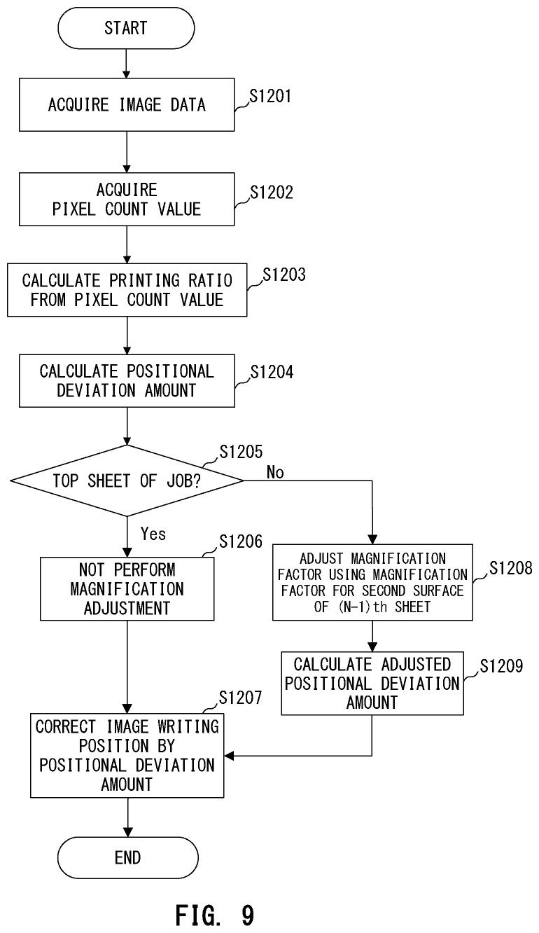

FIG. 8 is a flow chart for illustrating details of the image data correction at Step S1004 of FIG. 6. The CPU 114 corrects the image data one sheet at a time, starting from the sheet to be processed first (top sheet) in the print job. In the example illustrated in FIG. 7A, the sheet to be processed first (top sheet) in the print job is a sheet to which pages 4 and 5 are printed on the first surface, and pages 3 and 6 are printed on the second surface. As illustrated, the CPU 114 sets the number of sheets N to N=0 (Step S1101) and increments N by 1 (N=N+1) (Step S1102). The CPU 114 performs the position correction and the magnification adjustment for the image on the first surface of the Nth sheet (Step S1103), and performs the position correction and the magnification adjustment for the image on the second surface of the Nth sheet (Step S1104). Details of these processes are described later with reference to FIGS. 9 to 11. The CPU 114 determines whether the next sheet is present (Step S1105) or not. If the next sheet is not present (Step S1105: No), the image data correction processing ends. If the next sheet is present (Step S1105: Yes), the CPU 114 executes the processing from Step S1102 onwards again.

### <Image Data Correction Flow for First Surface>

First, the image data correction for the first surface is explained. FIG. 9 is a flowchart for illustrating the image data correction processing for the first surface of the Nth sheet. In FIG. 9, an example of the image position correction and the magnification adjustment, where the image center position is aligned with the sheet center position (fold position), is illustrated. The image data for the print job in saddle stitching includes an image assigned to the front half in the sub-scanning direction and an image assigned to the rear half in the sub-scanning direction. Similar to FIG. 5, these images are referred to as “image G1” and “image G2”, respectively.

The CPU 114 acquires the image data for the first surface of the Nth sheet to be printed (Step S1201) and acquires a pixel count value for the image G1 contained in the acquired image data from the pixel count unit 205 (Step S1202). The CPU 114 calculates the printing ratio of the image G1 from the pixel count value acquired in Step S1202 (Step S1203). The CPU 114 calculates the positional deviation amount of the trailing edge of the image G1, caused by the change in a sheet conveyance speed corresponding to the printing ratio, using Equation 1 based on the printing ratio acquired in Step S1203 (Step S1204).

The CPU 114 determines, in Step S1205, whether the Nth sheet is the top sheet of the job (N=1). In the saddle stitching, the sheet to be printed first in the job corresponds the innermost pages in a case where the printed sheets are stacked and folded in half. In the example of FIG. 7A, the sheet to be printed first corresponds to pages 4 and 5. As described above, the innermost two pages of the saddle stitching consist of the same sheet. In the present embodiment, the image magnification for each page on the same surface of the same sheet (pages 4 and 5 in the example of FIG. 7A) is set to be the same, thus, it is not necessary to perform processing to match the magnification factor on these pages. Therefore, in a case where the sheet is the top sheet of the job (N=1) (Step S1205: Yes), the CPU 114 does not perform the magnification adjustment to make the magnification factor for image magnification correction the same between the adjacent left and right pages of a spread (Step S1206). The CPU 114 uses the center position correction described in FIG. 5 to correct the image writing position in the image correction unit 207 so that the leading edge of the image G2 aligns with the center position of the sheet (Step S1207), then terminates processing.

In a case where the sheet is not the top sheet of the job (N+1) (Step S1205: No), the CPU 114 performs the magnification adjustment. In this case, the CPU 114 uses the magnification factor of the image determined by the magnification correction for the second surface of the (N−1)th sheet as the magnification factor of the image after the magnification adjustment (Step S1208). In the example illustrated in FIG. 7A, the magnification factor of the image of the second page printed on the first surface of the second sheet is identical to the magnification factor of the image of the third page printed on the second surface of the first sheet. Similarly, in the example illustrated in FIG. 7A, the magnification factor of the image of the seventh page printed on the first surface of the second sheet is identical to the magnification factor of the image of the sixth page printed on the second surface of the first sheet. In Step S1208, the CPU 114 serves as a magnification correction unit that applies the magnification correction to the image data for saddle stitching. The method for determining the magnification factor of the image for the second surface of the (N−1)th sheet will be described later. After performing the magnification adjustment, the CPU 114 calculates the amount by which the leading edge of the image G2 deviates from the sheet center position as the adjusted image positional deviation amount (Step S1209). Subsequently, the CPU 114 corrects the image writing position based on the adjusted image positional deviation amount (Step S1207) and terminates processing. This enables applying the same magnification correction to the first surface of the Nth sheet and the second surface of the (N−1)th sheet, which are adjacent left and right pages in a spread, thereby suppressing the sense of incongruity caused by differing magnifications.

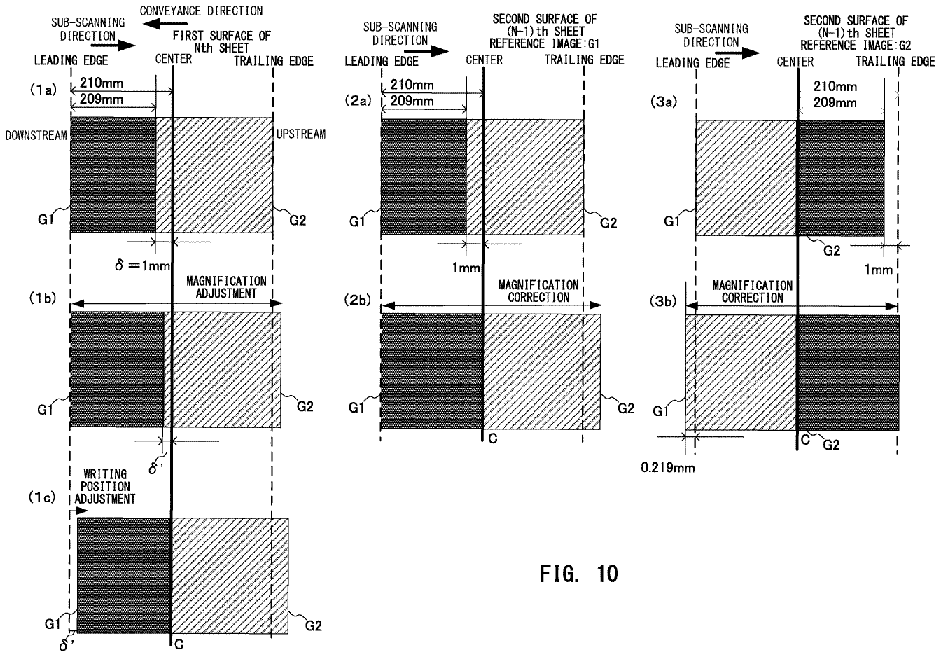

FIG. 10 is an explanatory diagram for illustrating the image data correction using specific numerical values when executing a saddle stitching job on A3 sheets. In this example, similar to (a) through (g) of FIG. 5, the positional deviation amount of the image G1 is illustrated as the distance “8” between the trailing edge of the image G1 and the center of the sheet (indicated as “C” in FIG. 10). Furthermore, in this example, the positional deviation amount at the leading edge of the image G2 from the center of the sheet position, calculated from the printing ratio at Step S1204, is 1 mm and illustrated as δ=1 mm in FIG. 10. The length of the image G1 in the sub-scanning direction is half the length of an A3 sheet in the sub-scanning direction, i.e., 210 mm. In this case, due to the printing ratio, the image G1 shrinks by 1 mm. If printed without the magnification correction, the length in the sub-scanning direction becomes 209 mm.

In FIG. 10, (la) is an explanatory diagram of the printed product illustrating a case in which no image data magnification adjustment is performed because it is determined in Step S1205 that it is the start of the job (N=1). In this case, as a result of the image G1 being shrunk by 1 mm, the leading edge of the image G2 is deviated by δ=1 mm from the sheet center position. In this case, the positional deviation of the image G1 is corrected by performing the center position correction described in (d) and (e) of FIG. 5 or by performing the magnification correction described in (f) and (g) of FIG. 5. This allows the trailing edge of the image G1 and the leading edge of the image G2 to be aligned with the fold.

In FIG. 10, (1b) is an explanatory diagram of the image data of the first surface illustrating a case in which the image data magnification adjustment is performed because it is determined in S1205 that it is not the start of the job (N>=2). In this case, the magnification adjustment is performed by setting the magnification factor of the image of the first surface of Nth sheet to the same value as the magnification factor of the image of the second surface of (N−1)th sheet at Step S1208. For example, if the magnification factor of the image of the second surface of (N−1)th sheet is determined to be 1.002, the magnification factor of the image of the first surface of Nth sheet is determined to be 1.002 through the magnification adjustment. Using the example in FIG. 7A with saddle stitching and N=2, “second surface of (N−1)th sheet” is the second surface of the first sheet in FIG. 7A, i.e., the surface on which pages 3 and 6 are printed, and its magnification factor of the image is already determined as 1.002. Further, “first surface of Nth sheet” is the first surface of the second sheet in FIG. 7A, i.e., the surface on which pages 2 and 7 are to be printed. In this example, during magnification adjustment, the magnification factor of the image for the first surface of the second sheet is determined to be 1.002 to match the magnification factor of the image of the second surface of the first sheet.

In a case where the magnification adjustment is not performed, the length in the sub-scanning direction of the printed product of the image G1 in the example of (1a) of FIG. 10 is 209 mm. However, by performing the magnification adjustment, the length in the sub-scanning direction of the printed output is 209*1.0002=209.418 mm. Therefore, in (1b) of FIG. 10, assuming that δ′ represents a positional deviation amount of the leading edge of the image G2 from the sheet center position, the value of δ′ is calculated in S1209 according to Equation 2 below.

δ′=210−(209×1.002)=0.582 (Equation 2)

Further, (1c) of FIG. 10 illustrates the result of delaying the image output timing so that the writing position in the sub-scanning direction moves 0.582 mm in the sub-scanning direction, based on the calculation result of Equation 2. As shown, the magnification adjustment results in the leading edge of the image G2 being positioned at the center of the sheet. As a result of the magnification adjustment, the image data for the second surface of the (N−1)th sheet and the first surface of the Nth sheet are subjected to the magnification correction at the same magnification (1.002 in this example). In the printed product after saddle stitching, both of the image G1 and the image G2 on the second surface of the (N−1)th sheet, and the image G1 and the image G2 on the first surface of the Nth sheet are subjected to the magnification correction at the same magnification. Therefore, the adjacent left and right pages of the spread is subjected to the magnification correction at the same magnification. As a result, a sense of incongruity caused by differing magnifications between images on adjacent left and right pages of a spread during the magnification correction is suppressed. In Steps S1209 and S1207, the CPU 114 serves as a writing position correction unit to correct the writing position of the image on the first surface of the Nth sheet. This writing position correction is performed based on the toner amount of the image G1 and the magnification of the adjacent left and right pages (e.g., the image G1 on the Nth sheet) of the spread.

### <Image Data Correction Flow for Second Side of Nth Sheet>

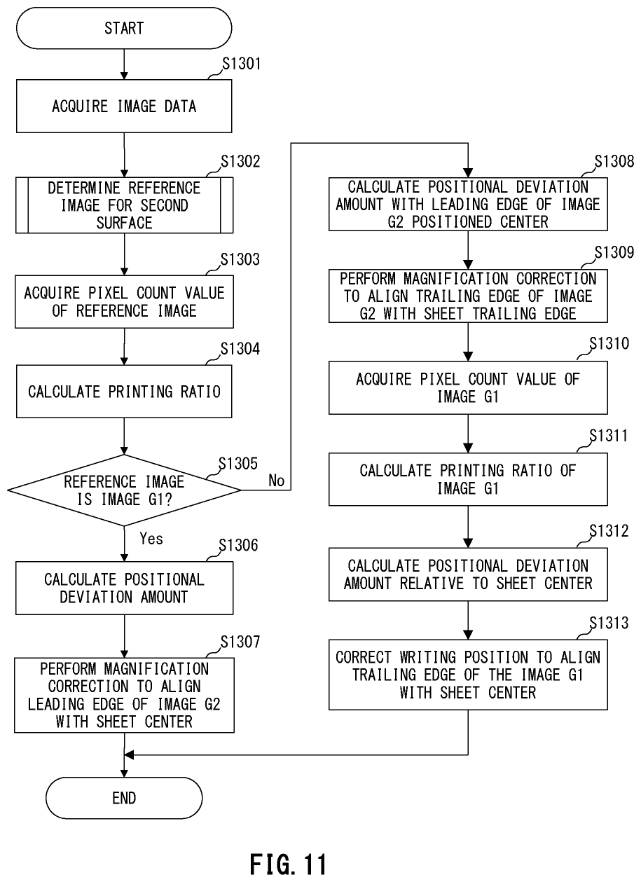

FIG. 11 is a flowchart for illustrating the image data correction processing for the second surface of the Nth sheet. The CPU 114 acquires the image data to be printed (Step S1301) and, in the magnification correction for the second surface of the Nth sheet, determines which of the pixel count values from the image G1 or the image G2 on the second surface of the Nth sheet is used to determine the magnification (Step S1302). Hereafter, the image determined in Step S1302 to be used to determine the magnification is referred to as the reference image.

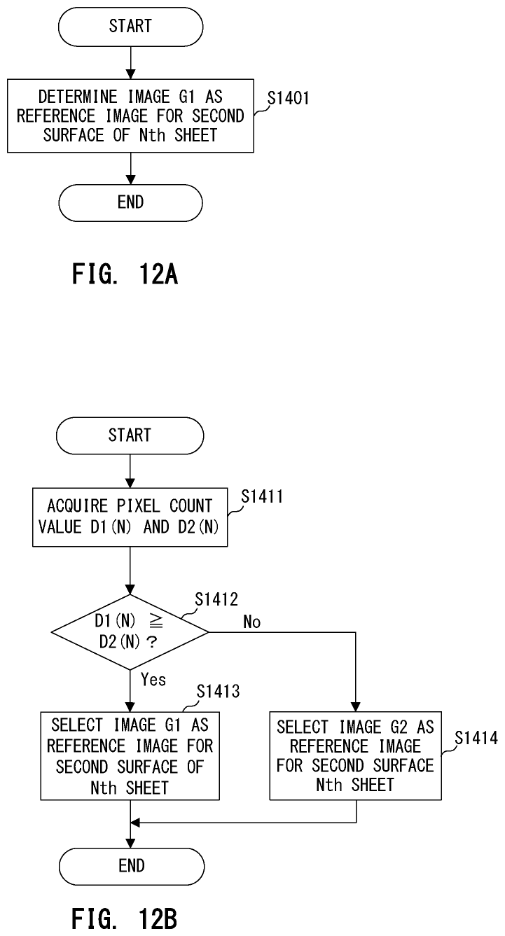

FIG. 12A is a flowchart for illustrating a first flow for determining a reference image for the second surface of the Nth sheet. In the first flow, the CPU 114 determines the reference image for the second surface of the Nth sheet to be the image G1 (Step S1401) and ends the process. That is, in the first flow, regardless of the pixel count values of images G1 and G2, the image G1 always becomes the reference image for the second surface of the Nth sheet. Alternatively, regardless of the pixel count values of pixels G1 and G2, the image G2 may always be set as the reference image for the second surface of the Nth sheet.

FIG. 12B is a flowchart for illustrating a second flow for determining the reference image for the second surface of the Nth sheet. The CPU 114 acquires the pixel count value D1(N) of the image G1 and the pixel count value D2(N) of the image G2 on the second surface of the Nth sheet (Step S1411). Then, the CPU 114 compares the pixel count value D1(N) and the pixel count value D2(N) (Step S1412) and selects the image with the higher pixel count value (i.e., the higher printing ratio) as the reference image. In a case where the pixel count values are equal, either the image G1 or the image G2 may be selected as the reference image, however, for simplicity of explanation, the image G1 is selected as the reference image in this case. Therefore, in a case where the CPU 114 determines that D1(N) is greater than or equal to D2(N) (D1(N)≥D2(N)) (Step S1412: Yes), the image G1 is selected as the reference image (Step S1413).

On the other hand, in a case where the CPU 114 determines that the pixel count value D1(N) is smaller than the pixel count value D2(N) (D1(N)≤D2(N)) (Step S1412: No), the image G2 is selected as the reference image (Step S1414). The CPU 114 may select the flow in FIG. 12A for simplifying control or for other reasons. On the other hand. The CPU 114 may select the flow in FIG. 12B to suppress the positional deviation due to printing ratio or for other reasons. Additionally, the selection between the first flow and the second flow may be determined manually. In this case, a screen for selecting either the first correction or the second correction may be displayed on the operation panel 120, and an operator inputs which correction to perform.

Returning to FIG. 11, the CPU 114 acquires the pixel count value of the reference image determined in Step S1302 of FIG. 11 at the pixel count unit 205 (Step S1303) and calculates the printing ratio of the reference image from the acquired pixel count value (Step S1304). The CPU 114 determines whether the reference image for the second surface of Nth sheet is the image G1 (Step S1305). In a case where the reference image is the image G1 (Step S1305: Yes), the CPU 114 calculates the positional deviation amount of the leading edge of the image G2 based on the printing ratio acquired in Step S1304. The positional deviation amount is calculated using the Equation 1, since the sheet conveyance speed changes according to the printing ratio (Step S1306). Calculating the positional deviation amount of the leading edge of the image G2 is substantially equivalent to determining the scaling amount (scaling ratio or magnification factor) in the conveyance direction of the image G1. The CPU 114 performs the magnification correction for the center position correction illustrated in (f) and (g) of FIG. 5 based on the calculated positional deviation amount.

Specifically, the CPU 114 performs the magnification correction for the center position correction described with reference to (f) of FIG. 5 by using the image correction unit 207, ensuring the leading edge of the image G2 on the printed product aligns with the sheet center position (Step S1307). As a result, similar to (g) of FIG. 5, the leading edge of the image G2 on the second surface of the Nth sheet can be aligned with the sheet center position on the printed product. In this case, no correction is required for the image writing position of the image G1, which is the image assigned to the downstream half region in the conveyance direction. On the other hand, in a case where the reference image is the image G2 on the second surface of the Nth sheet (Step S1305: No), it may be necessary to correct the image writing position after the magnification correction, in addition to correcting the magnification of the reference image. The CPU 114 then proceeds to process Step S1308.

Here, Steps S1306 to S1307 described above are explained in detail using specific numerical values, using an example of executing a saddle stitching job on an A3 sheet. First, a case where the reference image is the image G1 is explained. In FIGS. 10, (2a) and (2b) schematically illustrate the image data correction process in a case where the saddle stitching job is executed on an A3 sheet with the image G1 as a reference image. Further, it is assumed that the positional deviation amount, calculated in Step S1306, of the leading edge of the image G2 from the sheet center position is 1 mm. In this case, the length in the sub-scanning direction of the image G1 is 210 mm, which is half the length in the sub-scanning direction of the A3 sheet. As described above, if printing is performed without image data correction, the image G1 is shrunk by 1 mm, resulting in the length of 209 mm in the printed product.

In FIG. 10, (2a) is an explanatory diagram of the printed product in a case where the image G1, which is the reference image, is printed with a length of 209 mm. In this case, it is illustrated that the leading edge of the image G2 is deviated by 1 mm toward the leading edge of the sheet from the sheet center position. The magnification factor of the image required to correct this positional deviation is calculated as follows.

210/209=1.004 (Equation 3)

In FIG. 10, (2b) illustrates the image G2 in a case where the magnification correction using the magnification indicated in Equation 3 is performed, based on the calculation result of Equation 3, on the entire image data at Step S1307. As illustrated, by performing the magnification correction, the image G1 is printed with a length of 2 mm, and as a result, the leading edge of the image is positioned at the center of the sheet. Therefore, in a case where the image G1 is used as the reference image, no correction to the writing position is necessary.

Next, the case where the reference image is the image G2 is explained. In a case where the CPU 114 determines that the reference image is the image G2 (Step S1305: No), after printing has been performed such that the leading edge of the image G2, which is used as the reference image, is positioned at the sheet center position, the CPU 114 calculates a positional deviation amount between the trailing edge of the image G2 and a sheet trailing edge position. While the leading edge of the image G2 is at the sheet center position, the image G2 shrunk according to the printing ratio, causing the trailing edge to deviate from the sheet trailing edge position.

The CPU 114 calculates the positional deviation amount of the trailing edge of the image G2 relative to the sheet trailing edge position as described above (Step S1308). This positional deviation amount is calculated using Equation 1 from the printing ration acquired in Step S1304. The CPU 114 controls the image correction unit 207 to perform the magnification correction using the positional deviation amount calculated in Step S1308, in accordance with the method described with reference to (f) through (g) of FIG. 5 (Step S1309). The magnification used in this magnification correction is determined such that the leading edge of the image G2 on the printed product aligns with the sheet center position and the trailing edge aligns with the sheet trailing edge position, the details are described later.

Next, the CPU 114 acquires the pixel count value of the image G1 at the pixel count unit 205 (Step S1310) and calculates the printing ratio of the image G1 from the acquired pixel count value (Step S1311). The CPU 114 calculates the positional deviation amount of the trailing edge of the image G1 relative to the sheet center position, assuming the leading edge of the image G1 is the leading edge of the sheet, using the printing ratio acquired in Step S1311 and Equation 1 (Step S1312). The CPU 114 controls the image correction unit 207 to correct the writing position based on the amount of the positional deviation calculated in Step S1312 and the magnification determined using the image G2 so that the trailing edge of the image G1 on the printed product aligns with the sheet center position (Step S1313). The details are described later.

The processing in Steps S1308 to S1313 is explained in detail below. In the following example, both of the images G1 and G2 have a length of 210 mm in the sub-scanning direction. It is assumed that the image G1 has a length of 210 mm in the sub-scanning direction and, if printing is performed without the magnification correction, the image G1 is shrunk by 0.2 mm due to the printing ratio and to be printed with a length of 209.8 mm. Further, it is assumed that the positional deviation amount, calculated in Step S1308, of the trailing edge of the image G2 relative to the sheet trailing edge position is 1 mm in a case where printing is performed so that the leading edge of the image G2 aligns with the sheet center position.

In FIG. 10, (3a) illustrates the printed product where the trailing edge of the image G2 is deviated 1 mm toward the leading edge of the sheet from the sheet trailing edge position. The magnification factor of the image required to correct the positional deviation amount of the trailing edge of the image G2 is calculated in Step S1308 as follows.

210/209=1.004 (Equation 4)

In FIG. 10, (3b) illustrates an explanatory diagram in which the magnification correction is performed at a magnification of 1.004 on the entire image at Step S1309 based on the calculation result of Equation 4. As illustrated, in a case where the leading edge of the image G2 is positioned at the sheet center position, the trailing edge of the image G2 is positioned at the sheet trailing edge position by performing the magnification correction of Equation 4. The CPU 114 acquires the pixel count of the image G1 in Step S1310 and calculates the printing ratio from the pixel count value of the image G1 in Step S1311. In Step S1312, the CPU 114 calculates the image writing position based on the positional deviation amount at the sheet leading edge in a case where the magnification correction determined by Equation 4 is performed on the entire image. As described above, due to the printing ratio, the image G1 having the length of 210 mm in the sub-scanning direction is printed in a reduced size of 209.8 mm. In a case where the magnification correction is performed on the image having the length of 209.8 mm in the sub-scanning direction using the magnification determined by Equation 4, the length of the image in the sub-scanning direction in the printed product becomes 209.8*(210/209)≈210.804 mm in the printed product. The positional deviation amount by which the leading edge of the image G2 deviates from the sheet center position is calculated in Step S1312 as follows.

210−(209.8*(210/209))≈−0.804 (Equation 5)

Based on the result of Equation 5, adjusting the writing position so that the writing position in the sub-scanning direction moves 0.804 mm away from the center position places the leading edge of the image G2 at the sheet center position (Step S1313).

In FIG. 10, (3b) is an explanatory diagram of the image data after performing the magnification correction and a writing position adjustment. As shown, by adjusting the writing position so that the writing position in the sub-scanning direction moves 0.804 mm away from the center position, the leading edge of the image G2 is positioned at the sheet center position (Step S1313).

Thus, according to the present embodiment, it is possible to make the magnification factor of the image of the first surface of the Nth sheet and the second surface of the (N−1)th sheet identical while suppressing the positional deviation of the images G1 and G2 relative to the center position of the sheet. Therefore, it becomes possible to match the magnification of the corresponding left and right pages when opening the printed product of saddle stitching. Although the present embodiment has been described with reference to the example of saddle stitching as printing for saddle stitching, the present disclosure is applicable to printing in which any printing in which pages printed on different sheets may be positioned on the left and right sides of a fold so as to form a spread in a printed product, regardless of saddle stitching or not.

In the present embodiment, the magnification factor of the image is determined in the order of image formation sequence. Specifically, a magnification for a second surface of a sheet to be printed first is determined, and a magnification for a first surface of a sheet to be subsequently and continuously printed is then determined to be the same magnification as that determined for the second surface. However, the present disclosure is not limited thereto. For example, the magnification factor of the image is determined in the order of image formation sequence. Specifically, a magnification for a first surface of a sheet to be printed later is determined, and a magnification for second surface of a sheet to be precedingly and continuously printed is then determined to be the same magnification as that determined for the first surface. In this case, for the second surface of the Nth sheet, the image data for the first surface of the subsequent sheet (the (N+1)th sheet) is read in advance. Then, a central position correction and a magnification correction are performed on the image data of the first surface, and a magnification adjustment for the second surface is then performed according to the value of the magnification correction for the image data of the first surface. In this case, before correcting the image data for the Nth sheet, the image data for the first surface of the subsequent sheet is read in advance.

In the embodiment described above, the image data correction is performed sequentially starting from the first surface of the sheet. However, for each of the adjacent pages on a spread, it is also possible to identify image data including the page by any suitable method. In this case, the magnification correction is performed on the identified image data using a common magnification. To identify image data in this manner, it is possible, for example, to associate it with print property information containing the page number of the image within the image data, the type of printing (single-sided printing, double-sided printing, consolidated printing where multiple pages are printed on a single sheet, saddle stitching printing, etc.), and the printing order. The printing order is, for example, normal printing (forward order printing) or reverse order printing.

In this case, the CPU 114 can use the print property information to determine which pages in the printed product are adjacent across a fold as a spread, and whether these pages are printed on a first sheet and a second sheet different from the first sheet, respectively. The print property information is created based on user input during printing, such as whether saddle stitching is required or not, specified print pages, and print order, and is stored in a storage unit such as non-volatile memory 206. In this case, the CPU 114 reads the print property information and perform the magnification adjustment so that magnification correction is performed at a common magnification for both the image data for the first sheet and the image data for the second sheet, which is different from the first sheet.

According to the present disclosure, it is possible to provide an image forming technique capable of correcting image data at the same magnification between pages adjacent to each other on a spread.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-050658, filed Mar. 25, 2025, which is hereby incorporated by reference herein in its entirety.

What is claimed is:

1. An image forming apparatus comprising:
a conveyance unit configured to convey a sheet in a conveyance direction,
a printing unit configured to print an image on the sheet conveyed by the conveyance unit based on image data, and
a controller configured to:
print an image of a first page on a downstream side of a center position of a Nth sheet in the conveyance direction;
print an image of a second page on an upstream side of the center position of the Nth sheet in the conveyance direction;
print an image of a third page on an upstream side of a center position of a (N−1)th sheet in the conveyance direction;
print an image of a fourth page on a downstream side of the center position of the (N−1)th sheet in the conveyance direction;
perform saddle stitching in which the image of the first page and the image of the third page form a spread, and the image of the second page and the image of the fourth page form a spread;
perform a magnification correction on image data for the saddle stitching such that a magnification factor of the image to be printed on the first page is equal to a magnification factor of the image to be printed on the third page, and a magnification factor of the image to be printed on the second page is equal to a magnification factor of the image to be printed on the fourth page;
correct a writing position of the image to be printed on the Nth sheet by the printing unit, based on a toner amount of the image to be printed on the first page and the magnification factor of the image to be printed on the first page after the magnification correction, such that a downstream edge of the image of the second page is positioned at the center position of the Nth sheet in the conveyance direction.

2. The image forming apparatus according to claim 1,
wherein the controller is configured to perform the saddle stitching after the magnification correction is performed.

3. The image forming apparatus according to claim 1, wherein the controller is configured to determine a magnification factor in the magnification correction for the image of the third page and the image of the fourth page using one of the third page and the fourth page.

4. The image forming apparatus according to claim 3, wherein the controller is configured to compare an amount of toner used to form the image of the third page with an amount of toner used to form the image of the fourth page, and to determine the magnification factor for the magnification correction using the image corresponding to a larger amount of toner.

5. The image forming apparatus according to claim 1, wherein the controller is configured to perform the magnification correction such that a downstream edge of the image of the third page is positioned at the center position of the (N−1)th sheet.

6. The image forming apparatus according to claim 1,
wherein the controller is configured to perform the magnification correction using the image of the fourth page, and
wherein the controller is configured to correct a writing position of an image to be printed on the (N−1)th sheet by the printing unit such that an upstream edge of the image of the fourth page is positioned at the center position of the (N−1)th sheet.

7. The image forming apparatus according to claim 1, further comprising:
an image bearing member to bear a toner image, and
wherein the printing unit is configured to transfer the toner image of the image borne on the image bearing member on the sheet while the sheet is being conveyed by the conveyance unit.

8. The image forming apparatus according to claim 1, wherein the toner amount of the image to be printed on the first page is acquired using a printing ratio of the image.

9. The image forming apparatus according to claim 1, wherein the toner amount of the image to be printed on the first page is acquired using density values of the pixels included in the image.

10. The image forming apparatus according to claim 1,
wherein the image data is associated with print property information comprising a page number of the image included in the image data and a type of printing, and
wherein the controller is configured to determine, based on the print property information, to which of the first page, the second page, the third page, or the fourth page the image included in the image data corresponds.

11. An image forming apparatus comprising:
a conveyance unit configured to convey a sheet in a conveyance direction,
a printing unit configured to print an image on the sheet conveyed by the conveyance unit based on image data, and
a controller configured to:
print an image of a first page on a downstream side of a center position of a Nth sheet in the conveyance direction;
print an image of a second page on an upstream side of the center position of the Nth sheet in the conveyance direction;
print an image of a third page on an upstream side of a center position of a (N−1)th sheet in the conveyance direction;
print an image of a fourth page on a downstream side of the center position of the (N−1)th sheet in the conveyance direction;
perform saddle stitching in which the image of the first page and the image of the third page form a spread, and the image of the second page and the image of the fourth page form a spread;
perform a magnification correction on image data for the saddle stitching such that a magnification factor of the image to be printed on the first page is equal to a magnification factor of the image to be printed on the third page, and a magnification factor of the image to be printed on the second page is equal to a magnification factor of the image to be printed on the fourth page;
correct a writing position of the image to be printed on the Nth sheet by the printing unit, based on a toner amount of the image to be printed on the first page and the magnification factor of the image to be printed on the first page after the magnification correction, such that an upstream edge of the image of the first page is positioned at the center position of the Nth sheet in the conveyance direction.

12. The image forming apparatus according to claim 11,
wherein the controller is configured to perform the saddle stitching after the magnification correction is performed.

13. The image forming apparatus according to claim 11,
wherein the controller is configured to determine a magnification factor in the magnification correction for the image of the third page and the image of the fourth page using one of the third page and the fourth page.

14. The image forming apparatus according to claim 13, wherein the controller is configured to compare an amount of toner used to form the image of the third page with an amount of toner used to form the image of the fourth page, and to determine the magnification factor for the magnification correction using the image corresponding to a larger amount of toner.

15. The image forming apparatus according to claim 11, wherein the controller is configured to perform the magnification correction such that an upstream edge of the image of the fourth page is positioned at the center position of the (N−1)th sheet.

16. The image forming apparatus according to claim 11,
wherein the controller is configured to perform the magnification correction using the image of the fourth page, and
wherein the controller is configured to correct a writing position of an image to be printed on the (N−1)th sheet by the printing unit such that an upstream edge of the image of the fourth page is positioned at the center position of the (N−1)th sheet.

17. The image forming apparatus according to claim 11, further comprising:
an image bearing member to bear a toner image,
wherein the printing unit is configured to transfer the toner image of the image borne on the image bearing member on the sheet while the sheet is being conveyed by the conveyance unit.

18. The image forming apparatus according to claim 11,
wherein the toner amount of the image to be printed on the first page is acquired using a printing ratio of the image.

19. The image forming apparatus according to claim 11,
wherein the toner amount of the image to be printed on the first page is acquired using density values of the pixels included in the image.

20. The image forming apparatus according to claim 11,
wherein the image data is associated with print property information comprising a page number of the image included in the image data and a type of printing, and
wherein the controller is configured to determine, based on the print property information, to which of the first page, the second page, the third page, or the fourth page the image included in the image data corresponds.
